(19) United States
(12) Patent Application Publication
(10) Pub. No.: US 2009/0209190 A1
(43) Pub. Date: Aug. 20, 2009

(54) FILTER FOR AIR INTAKE OF AN AUTOMOBILE

(76) Inventor: David T. Gould, Kingston (CA)

Correspondence Address: ADE & COMPANY INC., 2157 Henderson Highway, WINNIPEG, MB, R2G1P9, CA

(21) Appl. No.: 12/034,038

(22) Filed: Feb. 20, 2008

(51) Int. Cl. B60H 1/26; B60H 3/06; B01D 46/10

(52) U.S. Cl. 454/158; 454/338; 55/495

(57) ABSTRACT

The air intake of a conventional automobile which is mounted in front of the windshield under the air intake cover at the rear of the hood is modified by the introduction into the duct of the air intake of a filtration pillow. The pillow is formed from a plurality of separate layers of filtration material including impregnated or particulate absorption material. The filter body is held in place either against a supporting grid or within a tray and held in place by hook type buttons adhesively attached to the grid or tray.

This invention relates to a filter for the cabin air intake of an automobile.

### BACKGROUND OF THE INVENTION

This invention relates to a passenger vehicle of the type having a vehicle body defining a passenger compartment with an air intake duct for drawing exterior air for emission into the passenger compartment, a fan mounted in the duct for drawing air into the intake and an air emission system within the passenger compartment for release of the air into the compartment.

Passenger vehicles and particularly automobiles are used to transport persons from place to place within a city and in most cases the motor propulsion of the passenger vehicle involves the production of combustion products which are released from the rear of one vehicle into the path of a following vehicle.

In many cities there is much concern about the level of air pollution particularly in the area of roads and freeways. The major thrust toward reduction of air pollution has been with regard to reducing the contaminants released during the combustion in the vehicle. However one area appears to have been fully overlooked which is that of preventing the entry of the contaminants into the passenger compartment by the provision of a filter member within the intake duct.

Some attempts have been made to apply a filter element into the air intake of a passenger vehicle. However, it is believed that none of these devices has been successful in the marketplace probably due to the complexity of manufacture and installation which has inhibited the public from using such devices.

However, the current attention to the environment and pollution has given a significant impetus to the desire for filtration of the air intake into the vehicle.

One proposed arrangement is shown in U.S. Pat. No. 3,870,495 (DIXSON) which shows a corrugated paper type filter of a relatively complex construction which is inserted into the duct in the form of a cup shape so that air enters the interior of the cup and passes through the paper filter material. This arrangement does not however take into account the specific designs of the intake duct system which is presently utilized in vehicles on the marketplace.

A filter construction is shown in U.S. Pat. No. 4,250,172 (MUTZENBERG) which discloses a plurality of layers of fibrous mat which are attached together by needling to form a pillow type-filter body. However this patent makes no disclosure as to how the construction may be attached into the intake duct of a vehicle.

In U.S. Pat. No. 5,350,172 (Gould) issued Sep. 27, 1994 is disclosed a plurality of layers of fibrous mat which are attached together by needling to form a pillow type filter body. This patent also discloses that the filter pillow may be attached into the intake duct of a vehicle using circular connecting disks or buttons which are adhesive on the rear and carry flexible hooks on the front which engage into the fibers of the filter pillow. These buttons are used in three separate installation techniques. In the first the pillow is inserted into a cover of an intake opening against a perforate wall of the cover and is held in place against that wall by the buttons which are arranged around a peripheral wall of the cover. In the second, the pillow is pressed up underneath an intake opening with an outer edge of the pillow engaging a flange surrounding the opening and being attached to the flange by the buttons. In the third, the pillow is rectangular and higher than the height of the duct and is inserted into a duct by bending across a center line so that the pillow is V-shaped and by attaching the end edges of the pillow to top and bottom walls of the duct using the buttons.

In U.S. Pat. No. 5,772,713 (Salinas) issued Jun. 30, 1998 is disclosed an adjustable filter assembly for a variety of filtration applications. The adjustable filter assembly includes a fixed-size filter medium and frame and an adjustable molding for adjustably applying said filter assembly in applications having widely varying dimensions. The filter assembly can take a variety of shapes and sizes so that any vent may be adequately fitted and filtered. The adjustability of the assembly is accomplished by the molding having at least one adjustable joint enabling the molding to be continuously adjusted from an un-extended position through to a fully extended position. In the un-extended position, the outside edge of the molding coincides with the perimeter of the filter media and the inner edge of the molding defines a minimum exposed area for the filter medium. In the fully extended position, the inner edge of the molding coincides with the perimeter of the filter media and the outside edge of the molding extends outwardly significantly beyond the perimeter of the filter media.

In U.S. Pat. No. 5,683,478 (Anonychuk) issued Nov. 4, 1997 is disclosed cylindrical air filter for use in the same situation.

### SUMMARY OF THE INVENTION

It is one object of the present invention, therefore, to provide a design of a simple filter member which can be mounted in the intake duct of a passenger vehicle so as to extract common pollutants from the air drawn into the vehicle.

According to a first aspect of the present invention, there is provided a passenger vehicle comprising:

a vehicle body having a passenger compartment;

an air intake duct for drawing exterior air for emission into the passenger compartment;

a fan mounted in the duct for drawing air into the intake;

the duct having a duct opening into which air is drawn by the fan;

and a filter member mounted in the duct opening upstream of the fan;

the filter member having a filter body arranged for extraction from air flowing therethrough of particulate materials and a filter medium in the filter body for extraction of combustion products;

the filter body comprising a plurality of layers connected together to form a pillow, some of the layers comprising a non-woven mat of fibres;

the filter member including a stiffening grid member formed of a plastics grid material defined by plastics wires arranged in an array with a series of crossing points between the wires in the array;

the grid member being located parallel to and on one side of the filter body and having edges dimensioned such that the grid member and the filter body are coextensive with the grid member supporting the filter body against flexing;

the grid member engaging wall portions surrounding the duct opening to provide support for the filter body at the duct opening;

and a plurality of fastening elements connecting the filter body to the grid member;

each fastening element having a rear surface adhesively fastened to the grid member at a crossing point thereon and a front surface carrying a plurality of flexible hooks carried on the element, the hooks engaging said non-woven mat of fibres to hold the filter body in place.

Preferably the fastening elements are circular in plan.

Preferably the fastening elements are arranged in an array at crossing points of the grid member spaced transversely and longitudinally across the grid member.

According to a second aspect of the present invention, there is provided a passenger vehicle comprising;

a vehicle body having a passenger compartment;

an air intake duct for drawing exterior air for emission into the passenger compartment;

a fan mounted in the duct for drawing air into the intake;

the duct having a duct opening into which air is drawn by the fan;

a filter tray;

the tray having a rectangular front wall defined by a plurality of transverse bars around which air can flow through the front wall;

the tray having four side walls at right angles to the front wall and each arrange along a respective side edge of the front wall;

the duct including a rectangular receptacle defining a lost along one edge such that the tray can slide through the slot into the rectangular receptacle;

and a filter member mounted in the duct opening upstream of the fan;

the filter member having a rectangular filter body arranged for extraction from air flowing therethrough of particulate materials and a filter medium in the filter body for extraction of combustion products;

the filter body comprising a plurality of layers connected together to form a pillow, some of the layers comprising a non-woven mat of fibres;

the filter body being shaped to sit in the tray against the front wall with side edges thereof in contact with the side walls of the tray;

and a plurality of fastening elements connecting the side edges of the filter body to the side walls of the tray;

each fastening element having a rear surface adhesively fastened to a respective side wall and a front surface carrying a plurality of flexible hooks carried on the element, the hooks engaging said non-woven mat of fibres to hold the filter body in place.

Preferably the fastening elements are circular in plan.

Preferably there are a plurality of fastening elements along each side wall.

Preferably the filter member is in the form of a pillow formed by a number of layers of filter material which are attached together at quilt lines longitudinally and transverse of the filter member. The filter layers preferably include at least some intermediate layers carrying a filter medium for extraction of combustion products. Activated carbon in particulate form can be used for the filter medium in which case it is generally encapsulated between separate layers of the filter member.

Preferably the filter member is supplied as a rectangular body of dimensions generally larger than the air intake for many different vehicles so that the filter member can be cut to size along the quilt lines to match an internal cross section of the inner duct wall. The thickness of the pillow and the stiffness of the material is then sufficient to frictionally engage the side edges of the pillow with the inner duct wall to hold the pillow in position solely by that frictional engagement.

The pillow construction is of a filter material which is stacked in layers and quilted either by stitch lines or heat sealing for the purpose of holding an activated charcoal (carbon) or similar medium between the layers.

The conventional automobile includes a windshield in front of which is the hood and rearwardly of which is the passenger compartment. Under the hood is provided the engine compartment which is separated from the passenger compartment by a fire wall. In front of the windshield is provided a fresh air intake cover which is generally removable to provide access to the inlet duct. Different vehicles have a different arrangement of the intake duct but generally the duct includes a duct wall having an inner duct surface leading from the position underneath the intake cover to the fan positioned forwardly or rearwardly as required of the fire wall.

When the intake cover has been removed, the pillow can be cut to shape adjacent the quilt lines depending upon the dimensions of the intake duct of the vehicle concerned and the pillow can then be inserted into the intake duct and the cover replaced.

The purpose of the filter member is to remove or reduce dust, dirt, pollen, toxins or pollutants to prevent them entering into the interior of the passenger compartment. This can be used to improve problems such as general health, asthmatic conditions or dust and dirt build-up within the vehicle. The filter can also extract some moisture and can prevent entry of snow or ice particles to prevent humidity build-up within the vehicle which can lead to fogging of the windows.

A pillow type filter can provide a lifetime of the order of three to twelve months depending upon usage and depending upon the level of pollutants within the air.

In one example the proposed filter pillow can be of the order of 12 inches by 15 inches panel quilted in 3 inch or 2 inch diagonal squares so it can be readily cut to size to match the cross section of the intake duct. Most automobiles currently on the market have easy access to the underside of the intake cover to allow simple installation of the pillow into the duct by the frictional effect.

### BRIEF DESCRIPTION OF THE DRAWINGS

One embodiment of the invention will now be described in conjunction with the accompanying drawing in which:

FIG. 1 is a partly broken away isometric view of a filter member of the present invention in a first installation arrangement for insertion into a vehicle.

FIG. 2 is a cross sectional view through the filter of FIG. 1.

FIG. 3 is a view similar to that of FIG. 2 showing the filter member of the present invention in a second installation arrangement.

FIG. 4 is a plan view of a further embodiment of filter member according to the present invention.

FIG. 5 is a cross sectional view of the filter member of FIG. 1 showing the air intake and the filter member of the present invention in a third installation arrangement.

In the drawings like characters of reference indicate corresponding parts in the different figures.

### DETAILED DESCRIPTION

A passenger vehicle shown in the above prior patent of Gould includes a passenger compartment and an engine compartment which is separated from the passenger compartment by a fire wall. At the front of the passenger compartment is provided a windshield positioned forwardly of a dash board including air outlet vents. Above the engine compartment is provided a hood and rearwardly of the hood is provided an air inlet cover which extends across the front of the windshield and includes openings or louvers through which air can be drawn into a compartment underneath the cover.

An air inlet system for drawing outside air into the passenger compartment includes a duct 21 mounted within the compartment 20 and leading to a fan housing 22 within which a fan 23 is mounted. The fan passes the air from the compartment through an opening in the fire wall with that air then escaping through the outlet.

The vehicle of the present invention is modified by the addition of a filter member 30 which is mounted within the inner duct wall. The filter member comprises a pillow 30A formed of a plurality of layers 32, 33 etc. of a filter medium. The pillow 30A is rectangular and formed from the layers which are co-extensive and terminate at defined side edges 29 and 31. The pillow is quilted by transverse and longitudinal quilt lines 34 and 35 or more preferably by diagonal arranged quilt lines formed either by stitching or by heat sealing to interconnect the layers. A number of the layers are formed from a conventional polyester filter material which is of the type formed from a non-woven mat of fibrous material. Intermediate the layers of the filter material are provided additional layers 36 which include an impregnated activated charcoal material carried within the layer. In one alternative the activated charcoal can be applied directly to a fibrous layer so as to be carried thereby. In an alternative arrangement the activated charcoal can be provided in powder or particulate form and carried between two layers of the filter material.

The layers are built up to a cushion having a thickness sufficient to provide a required filtration effect on the air drawn into the duct. In addition the thickness of the pillow is such that it has sufficient stiffness so that the side edges 29 and 31 of the pillow can engage against the side walls 60 and 61 of a tray 62 used to assist in holding the pillow in place.

In order to form the filter pillow into the required shape, an initial filter pillow of for example 12 inches by 15 inches can be cut to match the rectangular inside shape of the tray 62. The spacing between the quilt lines is selected so that in general the cut line lies outside the quilt lines so that the material within the filter member can expand outwardly at the edge for most effective attachment and filtration. The diagonal arrangement of the quilt lines is preferred for this.

The pillow of the present construction is formed of a filter material which is stacked in layers and quilted for the purpose of holding the activated charcoal or similar absorption medium between the layers. Other material in addition to or instead of the activated charcoal disclosed can be used to provide absorption of different pollutants as required. The filter member can be used to reduce or remove dirt, dust, pollen, toxins or pollutants such as combustion products including hydrocarbon, carbon monoxide, nitrogen oxides, soot and the like from the air drawn into the interior of the automobile. This improves general health, asthmatic conditions, dust and dirt build-up and moisture build-up. The filter can also prevent entry of debris such as leaves, and other unwanted entrants such as rodents, insects and the like. The panel of the order of 12 by 15 inches is preferably quilted in 2 or 3 inch squares so they can be cut to size and easily installed as explained above into most of the automobiles currently on the market place. The device is fitted as a retrofit arrangement without the necessity for a supporting frame or the modification to the intake hosing.

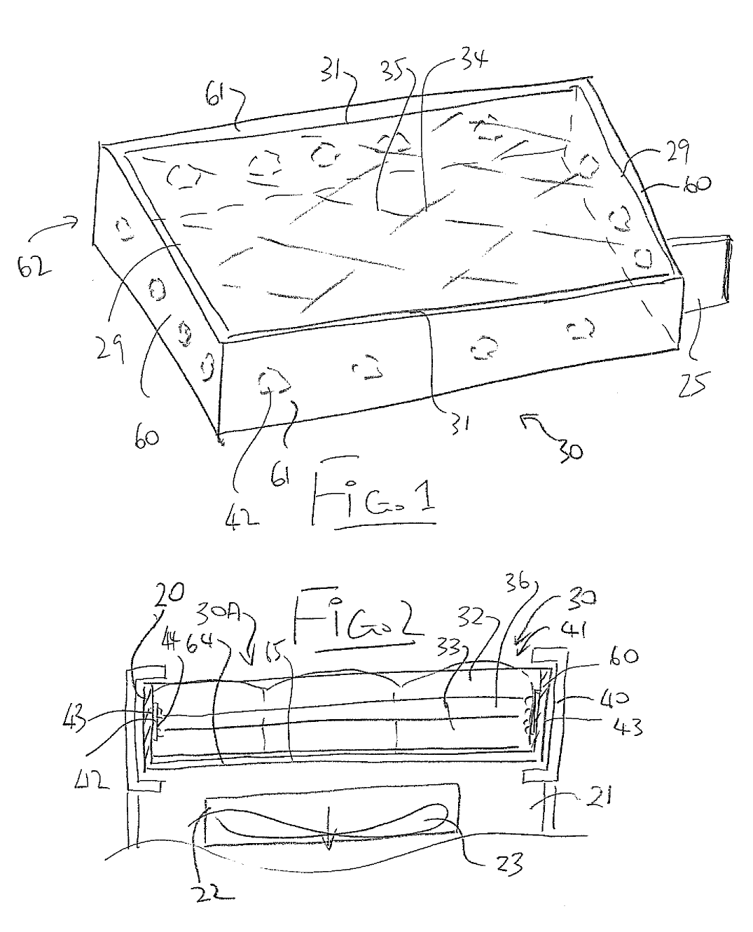

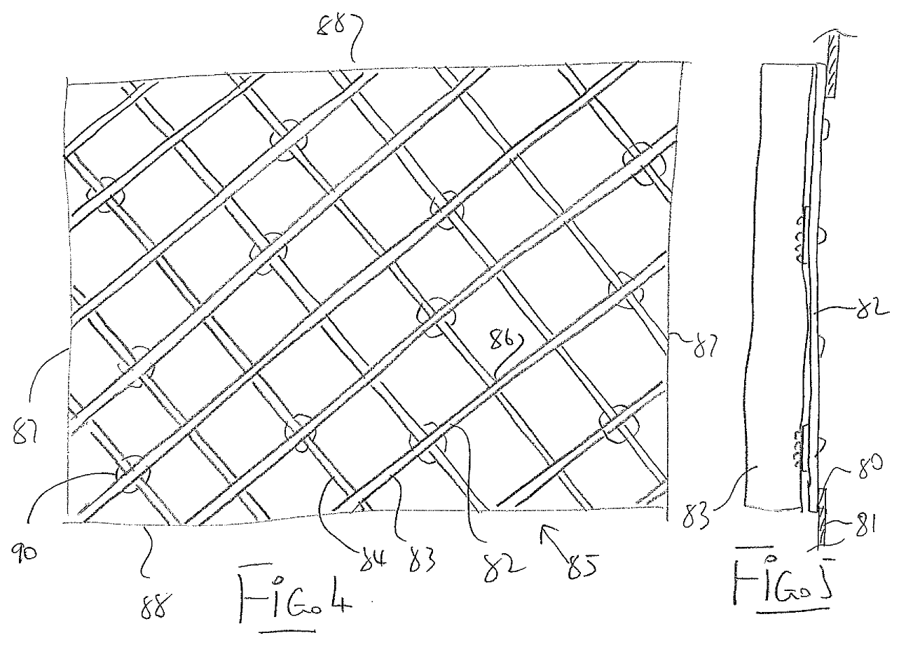

FIGS. 1, 2 and 3 show a first technique for the mounting of the filter element within the intake duct and FIGS. 4 and 5 show a second technique.

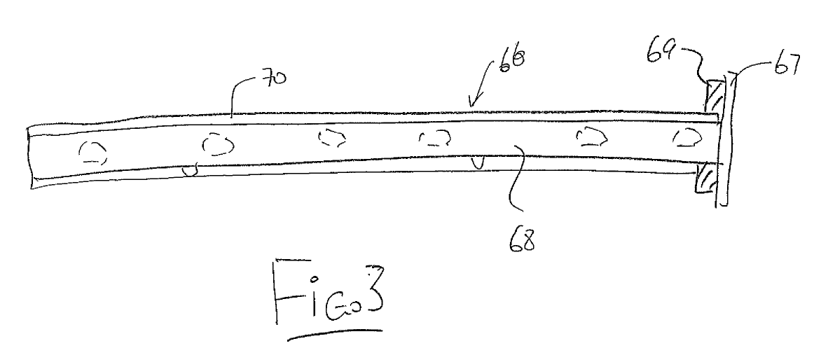

In FIGS. 1 and 2 the duct 21 includes a receptacle 40 at an inlet 41 through which air is drawn downwardly into a duct for communication to the fan. In the arrangement in FIG. 1, the receptacle forms a slot 43 into which the tray can be inserted by a sliding action along the receptacle from the slot at one end.

A base of the tray forms a front wall 64 defined by transverse bars 65 against which a front face of the filter pillow rests. The tray is inserted into the receptacle by a handle 25 on one side wall 29.

The filter member is fastened into the tray by a plurality of buttons 42 are located on inner surfaces of the side walls of the tray 62. The tray thus is rectangular and its side walls receive a plurality of separate circular button-type elements 42 attached thereto by adhesive layer 43. Each of the button elements is preferably circular in plan view but other shapes can be used. Each of the button elements has a plurality of flexible hooks 44 on the front surface thereof, that is the surface opposite to the adhesive layer. The hooks are of the type conventionally used in a hook and loop fastening system. As shown in FIG. 1, the button elements are positioned around the inside surface of the peripheral walls following which the pillow type filter body is inserted into the tray and the edges of the filter body engaged with the hook elements. As the filter element is formed of a non-woven polyester fibrous mesh, the hook elements engage effectively with the mesh to provide a vigorous attachment thereto.

In FIG. 3 is shown an alternative construction of tray 66 which is of reduced depth and has a raised side wall 67 on one side which acts as the end wall butting against one end of the receptacle. This wall has a sealing bead 69 of a foam material. A flange 70 along the top edge of the side walls 68 slides into a groove or slot in the housing into which the receptacle is provided.

In FIGS. 4 and 5 is shown an alternative arrangement in which the filter member is arranged to be inserted into an opening 80 in a wall 81. As the filter body 83 cannot span the opening without flexing or collapsing, it is supported by a stiffening grid member 82 formed of a plastics grid material defined by plastics wires 83 and 84 arranged in an array 85 with a series of crossing points 86 between the wires in the array. The grid member is located parallel to and on one side of the filter body 83 and has edges 87 and 88 dimensioned such that the grid member and the filter body are coextensive with the grid member supporting the filter body against flexing. The grid member engages wall portions 81 surrounding the duct opening 82 to provide support for the filter body at the duct opening. The plurality of fastening elements 90 of the type previously described connect the filter body to the grid member. Thus each fastening element 90 has a rear surface adhesively fastened to the grid member at a crossing point 86 thereon and a front surface carrying a plurality of flexible hooks carried on the element, the hooks engaging said non-woven mat of fibres to hold the filter body in place.

The filter can be supplied as a kit of parts including the rectangular filter pad for cutting to the required shape and a plurality of the fastener elements in the form of circular buttons having an adhesive layer on one side and the hooks on the opposed side. The user can therefore select the installation technique depending upon the type of vehicle and the construction is used in that vehicle and can them apply the fastener elements as required, cut the filter body to the required shape and attach it in the manner set forth above.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A passenger vehicle comprising:
a vehicle body having a passenger compartment;
an air intake duct for drawing exterior air for emission into the passenger compartment;
a fan mounted in the duct for drawing air into the intake;
the duct having a duct opening into which air is drawn by the fan;
and a filter member mounted in the duct opening upstream of the fan;
the filter member having a filter body arranged for extraction from air flowing therethrough of particulate materials and a filter medium in the filter body for extraction of combustion products;
the filter body comprising a plurality of layers connected together to form a pillow, some of the layers comprising a non-woven mat of fibres;
the filter member including a stiffening grid member formed of a plastics grid material defined by plastics wires arranged in an array with a series of crossing points between the wires in the array;
the grid member being located parallel to and on one side of the filter body and having edges dimensioned such that the grid member and the filter body are coextensive with the grid member supporting the filter body against flexing;
the grid member engaging wall portions surrounding the duct opening to provide support for the filter body at the duct opening;
and a plurality of fastening elements connecting the filter body to the grid member;
each fastening element having a rear surface adhesively fastened to the grid member at a crossing point thereon and a front surface carrying a plurality of flexible hooks carried on the element, the hooks engaging said non-woven mat of fibres to hold the filter body in place.

2. The vehicle according to claim 1 wherein the fastening elements are circular in plan.

3. The vehicle according to claim 1 wherein the fastening elements are arranged in an array at crossing points of the grid member spaced transversely and longitudinally across the grid member.

4. A passenger vehicle comprising:
a vehicle body having a passenger compartment;
an air intake duct for drawing exterior air for emission into the passenger compartment;
a fan mounted in the duct for drawing air into the intake;
the duct having a duct opening into which air is drawn by the fan,
a filter tray;
the tray having a rectangular front wall defined by a plurality of transverse bars around which air can flow through the front wall;
the tray having four side walls at right angles to the front wall and each arrange along a respective side edge of the front wall;
the duct including a rectangular receptacle defining a lost along one edge such that the tray can slide through the slot into the rectangular receptacle;
and a filter member mounted in the duct opening upstream of the fan;
the filter member having a rectangular filter body arranged for extraction from air flowing therethrough of particulate materials and a filter medium in the filter body for extraction of combustion products;
the filter body comprising a plurality of layers connected together to form a pillow, some of the layers comprising a non-woven mat of fibres;
the filter body being shaped to sit in the tray against the front wall with side edges thereof in contact with the side walls of the tray;
and a plurality of fastening elements connecting the side edges of the filter body to the side walls of the tray;
each fastening element having a rear surface adhesively fastened to a respective side wall and a front surface carrying a plurality of flexible hooks carried on the element, the hooks engaging said non-woven mat of fibres to hold the filter body in place.

5. The vehicle according to claim 4 wherein the fastening elements are circular in plan.

6. The vehicle according to claim 4 wherein there are a plurality of fastening elements along each side wall.
